(19) United States
(12) Patent Application Publication
(10) Pub. No.: US 2002/0119287 A1
(43) Pub. Date: Aug. 29, 2002

(54) Artwork and method of making the same

(76) Inventor: Charles A. Redlin, Watertown, SD (US)

Correspondence Address: David E. Bruhn, Dorsey & Whitney LLP, 220 South Sixth Street, Minneapolis, MN, 55402-1498, US

(21) Appl. No.: 09/792,739

(22) Filed: Feb. 23, 2001

(51) Int. Cl. B32B 3/02

(52) U.S. Cl. 428/141; 428/157

(57) ABSTRACT

The present invention relates to methods for making reproductions and reproductions made by the method, wherein the methods includes forming a reproduction body of layers of material, wherein the body has a generally flat, textured presentation surface and an edge region, wherein the edge region is deflected from said presentation surface.

### BACKGROUND

The present invention relates to methods for reproducing works of art and pieces of artwork made using the method. In one embodiment, the artwork made by the method of the present invention is a reproduction of an original work of art, such as a painting, print or the like, wherein the reproduction has features which give it characteristics simulating the original.

U.S. Pat. No. 5,721,041 (Baratto) discloses an art reproduction composite and method having a textured colored sheet having a thermoplastic layer and a color layer laminated to a substrate with an adhesive and optionally including a reinforcing layer. The patent is directed to providing high quality art reproductions and correctly indicates that “texture fidelity, i.e., the texture from the canvas and brush strokes” is a desired attribute of such reproductions. While citing U.S. Pat. No. 5,182,063 for its description of a method for producing texture on a print by embossing the print between male and female complemental embossing dies, the '041 patent is primarily directed to using a flexible thermoplastic layer and a flexible adhesive so that a reproduction may be stretched without cracking. The '041 method involves printing on a thermoplastic film and using a mold having relief characteristics, then applying a vacuum to draw the film into mold relief.

U.S. Pat. Nos. 4,971,743 (Lang), 4,001,062 (Iisaka et al.) and 4,308,224 (Becker) disclose methods for making reproductions wherein a relief mold taken from an original is used to shape a thermoplastic foil (Lang and Becker) or a moldment (Isaka et al.).

U.S. Pat. Nos. 5,182,063 (Lang et al.) and 5,201,548 (Lang et al.) are directed to a method and apparatus for making reproductions having coloration and three-dimensional texture using a photomechanically reproduced copy of an image on a carrier substrate which is suitable for embossing, the substrate being squeezed between embossing dies to produce a copy exhibiting the coloration and detail of the original image. These patents involve the creation of a mold-like “quasi-original proof or matrix.” and electrolytically forming an embossing die.

Notwithstanding the advances represented by the reproductions and methods disclosed in the above-mentioned patents, it would be advantageous if there were an improved, simplified, economical method of producing reproductions, and improved reproductions themselves, closely simulating an original work of art.

### SUMMARY

In one embodiment, the present invention provides a method for making a reproduction of an artwork and the reproduction made by the method.

In one embodiment, the present invention comprises a reproduction comprising a body formed of layers of material, the body having a presentation surface and an edge region, the edge region being deflected from the presentation surface and, in some embodiments, extending substantially completely around the perimeter of the presentation surface. In one embodiment, the body has a rear or back surface, and the edge region is curved toward the back surface. In one embodiment, the layers comprise a textured layer, and in some embodiments, the layers comprises a core having two sides, a print on one side of the core and a certificate on the other side of the core. The print may comprise a printed layer with a first side and a second side, and the printed layer may be coated on both sides. In some embodiments, the presentation surface is textured.

In one embodiment, the present invention provides a method of making a reproduction comprising the steps of printing, coating, layering, embossing and cutting, not necessarily in that order.

In one embodiment, the present invention provides a method for making reproductions and reproductions made by the method, wherein the method includes forming a reproduction body comprising layers of material, wherein the body has a generally planar, textured presentation surface and an edge region, and wherein the edge region is deflected from the presentation surface, advantageously giving the appearance that the reproduction is stretched.

An advantage of the present invention is that it facilitates creating a reproduction of an artwork which has characteristics that give it the appearance of the original artwork.

In one embodiment, the present invention relates to producing a reproduction comprising a print, a certificate and a core, wherein the print is coated on both sides and the certificate is coated on one side before being glued to the core. The assembled print, certificate and core are then cut to size, the cutting producing a pillow effect adjacent to the edges.

A feature of the present invention is an edge region associated with a piece of art, such as a print, reproduction or the like, wherein the edge region is curved to give the impression of a mat and, in some embodiments, may be a selected color. An advantage of the curved edge region is that it provides a perspective effect, enhancing the appearance of the reproduction.

In one embodiment, the present invention comprises a method of making a reproduction comprising the steps of providing a core having two sides and peripheral edges, adhering a print on one side of the core, wherein the print has peripheral edges and wherein the peripheral edges of the core and print are generally aligned, and cutting the generally aligned peripheral edges to provide cut edges of the core and print, wherein the cut edges are generally parallel, and wherein said cutting compresses the core adjacent to the cut edges. In some embodiments the print comprises a print layer coated on both sides by a film, wherein the film on one side may be embossed. In some embodiments, the embossing provides a woven looking texture and, in others, provides a linen texture. In some embodiments, the method of the present invention may comprise providing a contrast border adjacent to the cut edges, wherein the contrast border and the compressed portion of the core are generally congruent. In some embodiments, the contrast border may be more or less wide than the compressed portion.

A feature of the present invention is providing a core for supporting a print or the like, wherein the core has a thickness which is reduced adjacent to its edges, and wherein a print supported by the core substantially overlies the core and conforms to it, including overlying and conforming to the area adjacent to the edges where the core is thinner. This arrangement of core and print advantageously enhances the appearance the print by making it more closely resemble an original artwork done on a fabric material, e.g., linen, canvas or the like, wherein the fabric material is typically stretched and mounted, then framed.

Another feature of the present invention is providing a print or reproduction comprising second print or printed document layer comprising, in some embodiments, a “certificate of authenticity,” indicating, for example, the title of the print, the artist's name, the date, the purchaser, etc. In some embodiments, the second print layer may appear on the back or rear of the print or reproduction, and be integrated therewith.

In one embodiment of the method of the present invention, a piece of art, namely, a reproduction of a picture, is produced and comprises a generally planar central portion and an edge portion which is generally not coplanar with the central portion. The piece of art may further comprise a mat portion generally congruent with the edge portion, and further may comprise a layered body comprising a core and a print layer. In one embodiment, the print layer is embossed to provide a texture and, in some embodiments, comprises a center graphic or printed layer with a transparent film on each side. In some embodiments, it may be the film on one side which is embossed.

In some embodiments, the method of the present invention involves creating a plurality of reproductions, wherein the reproductions give the appearance of being an original.

Another advantage of the methods and apparatus of the present invention is that they may be used to create a large number of reproductions, each having characteristics which give it the quality and appearance of the original.

Other features and advantages of methods and reproductions of the present invention will become more fully apparent and understood with reference to the accompanying description, drawings and claims.

### BRIEF DESCRIPTION OF THE DRAWINGS

FIG. 1 depicts a portion of an embodiment of the present invention.

FIG. 2 is a sectional view of the embodiment of FIG. 1.

FIG. 3 is a flow diagram depicting one embodiment of the method of the present invention.

### DETAILED DESCRIPTION

The accompanying Figures and this description depict and describe embodiments of a process or method and the product thereof, a reproduction, in accordance with the present invention, and features, steps and components thereof. As used herein, the terms “reproduction” and “print” (and their plurals) are intended to encompass a piece of art, including any replica, replication, simulation, copy or the like of an original work of art, such as a painting, print, watercolor, etching, drawing, printed document, photograph or the like. Unless specifically disclosed or taught, any method of producing a print may be used in the present invention.

In some embodiments, the method of the present invention may comprise suitable processing machines and the like, at various locations, and the steps may be performed at various locations. The steps may be performed under control of a microprocessor or the like. Although machine processing and electronic control of the processing are contemplated, the method of the present invention may also be performed or carried out completely or in part by hand, i.e., steps of the method, which may include printing, coating, embossing, layering and/or cutting, may be done by hand. If computer control is used, the program logic could be either hardware, software, or a combination of both.

Unless specifically disclosed or taught, any suitable electronic devices and coupling or linking methods and apparatus may be used in the present invention, for example, the present invention may incorporate appropriate microprocessors, integrated circuits, chips, electronic printing methods and devices, sensors, wireless links, internet links, telephony, optical fiber technology, data storage technology, etc.

Any references to positional and/or temporal locations, e.g., the order of processing or steps, are intended for convenience of description, not to limit the present invention to any one positional or temporal orientation.

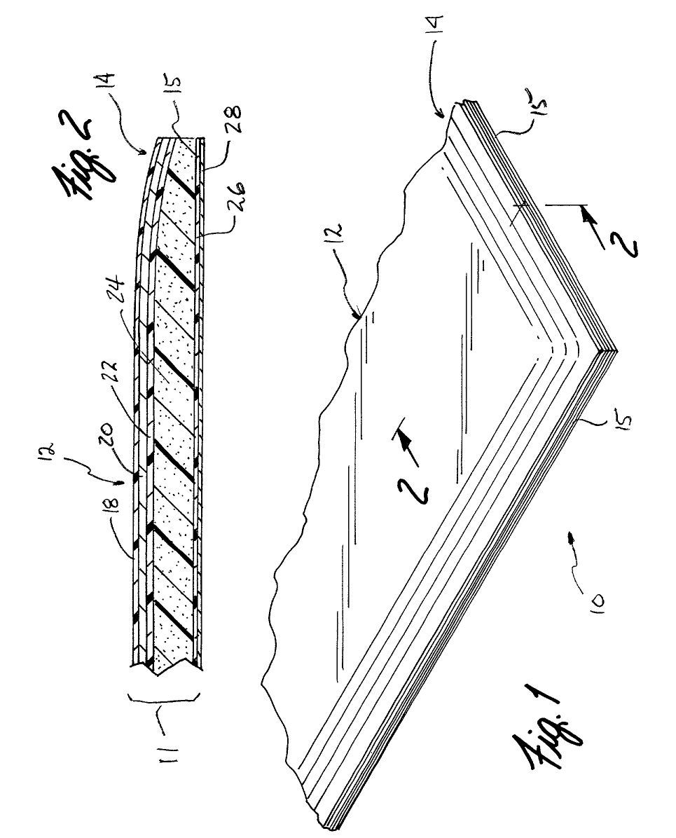

Referring to FIG. 1, a reproduction 10 made by one embodiment of the method of the present invention includes a viewable, generally central, graphic or image carrying presentation surface 12 and an edge portion 14. Any graphic or image may be presented on the presentation surface 12. In one embodiment, the edge portion 14 extends continuously around the presentation surface 12, and is generally not co-planar with the presentation surface 12. In some embodiments, the edge portion 14 may be a selected color and/or have a selected texture to, for example, accentuate its departure from the plane of the presentation surface 12 and/or to highlight or complement the image of the presentation surface 12. Although reproductions are generally geometrically shaped, e.g., rectangular, a reproduction in accordance with the present invention may be variously shaped and, unless specified herein, may be of various sizes.

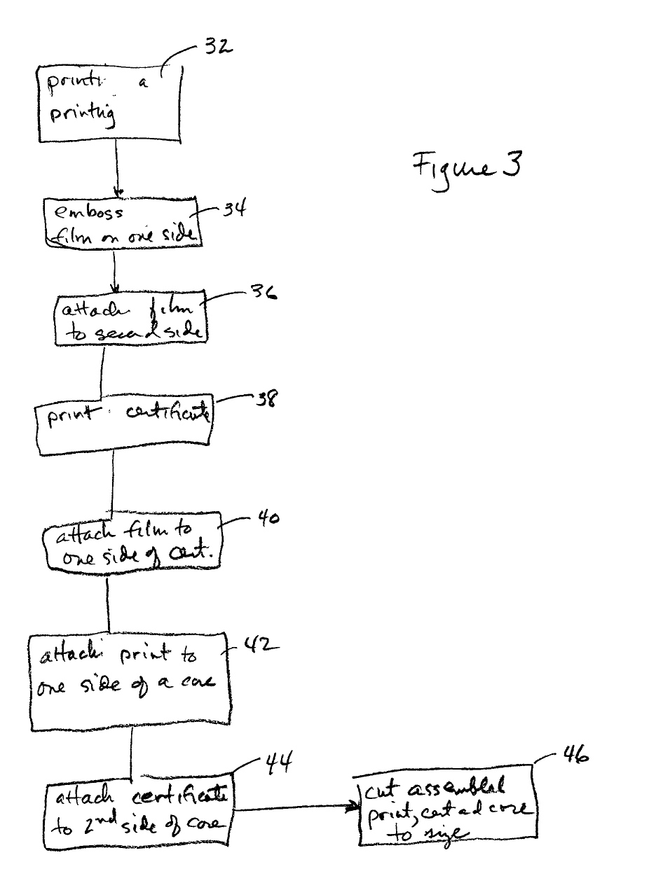

FIG. 2 depicts additional structural details of a reproduction 10 in accordance with the present invention. In particular, it depicts that the reproduction 10 comprises an assembly 11 of multiple layers. The layers comprise a first film layer 18, a print layer 20, a second film layer 22, a core 24, a third film layer 26, and a certificate layer 28. A suitable adhesive may be used between the second film layer 22 and the core 24 to adhere the first film layer 18, print 20 and second film layer 22 to the core 24. Similarly, a suitable adhesive may be used between the third film layer 26 and core 24 to adhere the third film layer 26 and the certificate 28 to the core 24. FIG. 2 further depicts that a reproduction in accordance with the present invention has a “pillow effect,” wherein the edge portion 14 is thinner than the remainder of the assembly 11. The generally central portion 12 is and appears to be thicker than the edge portions 14. In some embodiments, this effect may be achieved during a cutting of the assembly 11 of layers to size and, in other embodiments, it may be achieved by a separate step, e.g., by compressing the peripheral edge region of the reproduction before or after cutting.

Referring to FIG. 3, in one embodiment, the present invention provides a method for making a print which gives the appearance of a work of art done on canvas. In this embodiment, the method comprises printing 32 a print or the like, selecting and embossing 34 a first film on the graphic side of the print, selecting and attaching 36 a second film to the other side of the print, printing 38 a certificate or the like, attaching 40 a film to one side of the certificate, attaching 42 the print and the sandwiching films to one side of a supporting core 24, attaching 44 the certificate and film to the other side of the core 24, and cutting 46 the assembled print/films, core and certificate/film to a desired size.

In one embodiment, the paper used for the print is a 120 pound, manufactured archival cover paper with a silk finish. Other paper may be used as long as the selected paper is well-suited for making art print reproductions.

In one embodiment, the printed or presentation side of the selected paper is covered with a UV resistant, 3 mil. poly film, and the film/print is embossed or pressed with a suitable embossing roller or the like to impart a textured, linen-like finish or surface. The embossing is conducted using relatively high heat and pressure sufficient to provide for proper deformation of the film and for proper adherence of the film to the print, with minimum break through or tearing of the film and without damaging the printed surface lying beneath it. The film may be knife trimmed or cut to a useful size before or after being applied to the print.

In one embodiment, the non-printed side of the paper is coated with a 5 mil. poly film using relatively moderate heat and pressure, with minimum break through, and knife trimmed. The applied heat and pressure should be selected to give a smooth finish, making sure all bubbles are out.

Thus, one component of the present invention is a print, coated on both sides with a poly film, wherein the film on the display or presentation side of the print is embossed to give the appearance that the print was done on a fabric, such as linen or canvas. Other textures may be embossed or pressed into or onto the film or the assembled film or films and print. For example, a texture giving the appearance of brush or pallet knife strokes may be formed to give the impression of a painted original oil. In some embodiments, the embossing may be matched to portions of the picture or print to enhance the effect of an original.

In one embodiment, the rear or back side of the reproduction 10 produced by the method of the present invention, the certificate side, may be made from a 60 pound parchment paper. The parchment certificate side is smoothly coated on its non-printed side with a 1.3 mil. poly film, with, in one embodiment, the film running to the edge of the paper.

In some embodiments, the art prints and/or certificates of the present invention may be printed using a suitably formulated fade resistant ink, for example, that manufactured by Toyo.

In one embodiment, the print, coated on both sides with suitable film, and certificate, coated on one side with suitable film, are mounted on a suitable mounting substrate or core 24, for example a 20×35, ¼ inch jet mount made by Fome Core. The process of mounting comprises mounting the parchment paper certificate to the jet mount, with the poly film 26 adjacent to the core, using a suitable hi-tack, fast acting cold adhesive with a minimum amount of water. Sufficient pressure is used to press the certificate in place smoothly. The print 20 is mounted on the other side of the foam core with the 5 mil. film 22 next to the core 24 using a suitable hi-tack, fast acting cold adhesive with a minimum of water. Again, sufficient pressure is applied, for example, by a roller or rollers, to press the print in place smoothly on the core 24.

In one embodiment, the die cutting or cutting the reproduction 10 to size is accomplished using a suitable cutting device or devices such as a steel cut rule, e.g., a ribbon-like body of steel with one sharp edge which can be formed into a desired shape, in this instance a rectangle. In one embodiment, the cutting of the assembled layers 11 is done from the art print side to create a “pillow” effect, i.e., the assembled layers 11 are thicker in the generally central area 12 and thinner adjacent to the cut edges 15. Any suitable cutting method may be used as long as it acts to deflect, crush or compress the core 24, making the assembled print, core and certificate thinner adjacent to the edges 15. Also, in some embodiments, the process of making the edge portions thinner may be a separate step, e.g., after the assembled layers are cut, the area adjacent to the cut edges may be heated, compressed or otherwise deformed so that it remains thinner than the remainder of the assembly. In other words, the generally central portion of the surface of the presentation or picture side of the finished, assembled reproduction is farther from the back side (the side carrying the certificate) than the edges. In some embodiments, the edge portion, which in some embodiments is thinner than the remainder of the product, may be colored to highlight the image and/or the pillow effect. In some embodiments, the edge portion may be differently textured. In some embodiments, the film overlaying the print, on the print side, may have an edge portion having characteristics different than the generally central portion of the film, e.g., it may be transparent, semi-transparent or opaque. In one embodiment, the uncompressed core 24 may be a 1/4 inch thick and, after finishing, the edge region 14, particularly immediately adjacent to the cut edges 15, may be approximately an 1/8 inch in thickness. The thickness of the central portion and the edge portion may be varied selectively, other ratios of thickness may be provided or, as depicted in FIGS. 1 and 2, the edge portion 14 may be curved.

During the making or processing of the reproduction 10 in accordance herewith, a padded pusher assembly is used to eject the formed and cut print from the processing apparatus to avoid damaging the edges of the reproduction 10.

The present invention may be embodied in other specific forms without departing from the essential spirit or attributes thereof, and it may be used to reproduce a wide variety of pieces of art. Described embodiments should be considered in all respects as illustrative, not restrictive.

What is claimed is:

1. A reproduction of an artwork simulating the original artwork and comprising a body formed of layers of material, said body having a presentation surface and an edge region, said edge region being deflected from said presentation surface.

2. The reproduction according to claim 1, said body having a back surface, said edge region curved toward said back surface.

3. The reproduction according to claim 1, wherein said layers comprise a textured layer.

4. The reproduction according to claim 1, said layers comprising a core having two sides, a print on one side of the core and a certificate on the other side of the core.

5. The reproduction according to claim 4, wherein said print comprises a printed layer with a first side and a second side, the printed layer coated on both sides.

6. The reproduction according to claim 4, wherein one of the first and second sides is textured.

7. A method of making a reproduction comprising the steps of:
providing a core having two sides and peripheral edges;
adhering a print on one side of the core, wherein the print has peripheral edges and wherein the peripheral edges of the core and print are generally aligned; and
cutting the generally aligned peripheral edges to provide cut edges of the core and print, wherein the cut edges are generally parallel, and wherein said cutting compresses the core adjacent to the cut edges.

8. The method according to claim 7, wherein the print comprises a print layer coated on both sides by a film.

9. The method according to claim 8, further comprising embossing one side of the coated print layer.

10. The method according to claim 9, wherein said embossing provides a woven looking texture.

11. The method according to claim 10, wherein said woven looking texture comprises a linen texture.

12. The method according to claim 7, further comprising providing a contrast border adjacent to the cut edges.

13. The method according to claim 12, wherein the contrast border and the compressed portion of the core are generally congruent.

14. A reproduction of an original artwork comprising a generally planar central portion and an edge portion which is generally not coplanar with the central portion.

15. The reproduction according to claim 14, further comprising a mat portion generally congruent with the edge portion.

16. The reproduction according to claim 14, further comprising a layered body comprising a core and a print layer.

16. The reproduction according to claim 15 wherein said print layer is embossed to provide a texture.

17. The reproduction according to claim 16, wherein said print layer comprises a center layer with a film on each side.

18. The reproduction according to claim 17, wherein one of said sides is embossed.
